(19) United States
(12) Patent Application Publication
(10) Pub. No.: US 2007/0193023 A1
(43) Pub. Date: Aug. 23, 2007

(54) Method of manufacturing magnetic head

(75) Inventors: Kiyotaka Maruyama, Kawasaki (JP); Kiyotaka Nara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/429,875

(22) Filed: May 8, 2006

(30) Foreign Application Priority Data
Feb. 17, 2006 (JP) 2006-40162

(51) Int. Cl. G11B 5/133

(52) U.S. Cl. 29/603.01; 360/127; 360/317; 29/603.13; 29/603.15

(57) ABSTRACT

The method of manufacturing a magnetic head is capable of securely insulating coils in different layers when the magnetic head including a lower magnetic pole, an upper magnetic pole and a write-head constituted by a plurality of the layered coils is produced. The method of manufacturing a magnetic head, which includes a write-head, constituted by a plurality of layered coils, comprises the steps of: forming a tip magnetic pole section, which is located at a front end of the lower magnetic pole, and the coil of the first layer on a surface of a substrate; polishing the entire surface of the substrate so as to make the entire surface of the substrate, which includes a surface of the tip magnetic pole section and a surface of the coil of the first layer, even flat face; coating the surface of the substrate other than specific parts, which electrically insulate the coil of the first layer from the coil of a second layer, with resist; coating the entire surface of the substrate with an insulating layer; removing the insulating layer from the specific parts together with the resist by liftoff; and forming the coil of the second layer on the insulating layer formed on the substrate.

### BACKGROUND OF THE INVENTION

The present invention relates to a method of manufacturing a magnetic head, more precisely relates to a method of manufacturing a magnetic head having a write-head, in which a plurality of write-coils are layered.

An example of a conventional magnetic head of a magnetic disk drive unit is shown in FIG. 3. The magnetic head has a read-head 8, in which a reproducing element 5 is sandwiched between a lower shielding layer 6 and an upper shielding layer 7, and a write-head 10, which includes a lower magnetic pole 12, which is located on one side of a write-gap 11 and which acts as the upper shielding layer 7, and an upper magnetic pole 13. The write-head 10 further includes coils 14, which generate write-magnetic fields between tip magnetic pole sections of the magnetic poles 12 and 13. The coils 14 are formed between the magnetic poles 12 and 13 and wound around a connecting section 15.

In some cases, the coils 14 are formed as a single-layer. In the case shown in FIG. 3, the coils 14 are layered as two coil layers or more. When the coils 14 are layered, an insulating layer or layers are formed between the coil layers so as to prevent electric short.

A conventional method of manufacturing the magnetic head, in which the coils 14 are layered, will be explained with reference to FIGS. 4A-4D.

In FIG. 4A, an insulating layer 20, which is an inorganic insulating film of an oxide, a nitride, etc., e.g., alumina, SiO₂, is formed on a surface of the lower magnetic pole 12. A patterns of coil 14a of the first layer is formed by plating. A tip magnetic pole section 12a of the lower magnetic pole 12 is formed. In the actual manufacturing process, the coil 14a and the tip magnetic pole section 12a are formed, then an entire surface of a work piece is polished until surfaces of the tip magnetic pole section 12a and the coil 14a are exposed. The polished surfaces of the tip magnetic pole section 12a and the coil 14a are included in the same horizontal plane as shown in FIG. 4A (see Japanese Patent Gazette No. 2001-250203). Note that, a spiral space in the coil 14a is filled with resist 22.

In FIG. 4B, another inorganic insulating film 24 of an oxide, a nitride, etc., is formed on the entire surface of the work piece by sputtering. Therefore, the coil 14a of the first layer is electrically insulated from a coil 14b of a second layer by the insulating layer 24.

In FIG. 4C, resist patterns 26 are formed on a surface of the insulating layer 24, then the insulating layer 24 is ion-milled so as to expose specific parts of the insulating layer 24, which correspond to the tip magnetic pole section 12a, the connecting section 15a and a connecting section 14c connected to a coil 14b of the second layer.

In FIG. 4D, the specific parts of the insulating layer 24, which covered the surfaces of the tip magnetic pole section 12a, the connecting section 15a, are removed by ion milling, then the resist 26 is also removed. The ion milling is performed so as to maintain electric conductivity when a magnetic layer is formed on the tip magnetic pole section 12a, the connecting section 15a.

Conventionally, when the coils 14 are layered in the write-head of the magnetic head, unnecessary parts of the insulating layer 24 are removed by ion milling. To perfectly remove the insulating layer 24 from the surfaces of the tip magnetic pole section 12a and the connecting sections 14c and 15a, the surfaces of the tip magnetic pole section 12a and the connecting sections 14c and 15a are slightly grooved by ion milling. Parts A shown in FIG. 4D are the grooved parts.

Conventionally, the tip magnetic pole section 12a is large, and a pattern of the coil 14 is wide. Therefore, the unnecessary parts of the insulating layer 24 can be easily removed by ion milling. However, recent magnetic heads are very small, and components parts of write-heads must be minute. So, it is very difficult to uniformly and precisely remove the unnecessary parts of the insulating layer 24 from an entire wafer by ion milling. Since amounts of grooving the tip magnetic pole section 12a and the connecting sections 14c and 15a are varied, thickness of the resist coating them must be varied, so that accuracy of patterning the resist must be lowered.

### SUMMARY OF THE INVENTION

The present invention was conceived to solve the above described problems.

An object of the present invention is to provide a method of manufacturing a magnetic head, which is capable of securely insulating coils in different layers when the magnetic head including a write-head constituted by a plurality of the layered coils is formed and which is capable of easily and securely manufacturing the magnetic head with securely removing unnecessary parts of an insulating layer when a magnetic pole is formed.

To achieve the object of the present invention, the present invention has following constitutions.

Namely, the method of manufacturing a magnetic head, which includes a lower magnetic pole, an upper magnetic pole and a write-head, which is sandwiched between the magnetic poles and constituted by a plurality of layered coils, comprises the steps of: forming a tip magnetic pole section, which is located at a front end of the lower magnetic pole, and the coil of the first layer on a surface of a substrate; polishing the entire surface of the substrate so as to make the entire surface of the substrate, which includes a surface of the tip magnetic pole section and a surface of the coil of the first layer, even flat face; coating the surface of the substrate other than specific parts, which electrically insulate the coil of the first layer from the coil of a second layer, with resist; coating the entire surface of the substrate, on which the resist has been applied, with an insulating layer; removing the insulating layer from the specific parts together with the resist by liftoff; and forming the coil of the second layer on the insulating layer formed on the substrate.

The method may further comprise the step of forming a tip magnetic pole section of an upper layer, which is electrically connected to the tip magnetic pole section. By coating the surface of the tip magnetic pole section with the resist, coating the surface of the substrate with the insulating layer and lifting off the insulating layer, the insulating layer is removed from the surface of the tip magnetic pole section. Further, the surfaces of the tip magnetic pole section and the coil of the first layer are included in the same plane, so that the coil, etc. of the second layer can be precisely formed.

In the method, a connecting section, which connects the lower magnetic pole with the upper magnetic pole, may be formed when the tip magnetic pole section is formed in the surface of the substrate, and the entire surface of the substrate, which includes the surface of the tip magnetic pole section, the surface of the coil of the first layer and a surface of the connecting section, may be polished and formed into the even flat face. In this case, the insulating layer can be securely removed from the surface of the connecting section when the magnetic head is manufactured.

The method may further comprise the steps of: polishing the entire surface of the substrate, which includes the surface of the coil of the second layer, so as to make the entire surface even flat face; coating the surface of the substrate other than specific parts, which electrically insulate the coil of the second layer from a coil of a third layer, with resist; coating the entire surface of the substrate, on which the resist has been applied, with another insulating layer; removing the insulating layer from the specific parts together with the resist by liftoff; and forming the coil of the third layer on the insulating layer formed on the substrate. With this method, in case of forming the coils of three layers or more, the coils can be mutually securely insulated and precisely formed.

By employing the method of the present invention, the insulating layer, which insulates the coil of the first layer from the coil of the second layer, can be securely formed between the layers. Further, in the lifting off step, the entire surface of the substrate is polished after forming the coil of the first layer and the tip magnetic pole section. The tip magnetic pole section, whose surface has been made flat, can be processed in the following step in the state, in which the surfaces of the tip magnetic pole section and the coil are included in the same horizontal plane. Therefore, component parts of the magnetic head can be precisely formed, and a minute magnetic head can be precisely formed.

### BRIEF DESCRIPTION OF THE DRAWINGS

Embodiments of the present invention will now be described by way of examples and with reference to the accompanying drawings, in which:

FIGS. 1A-1D are explanation views showing the steps of manufacturing a magnetic head of the present invention;

FIGS. 2A-2C are explanation views showing further steps of manufacturing the magnetic head of the present invention;

FIG. 3 is a sectional view of the ordinary magnetic head; and

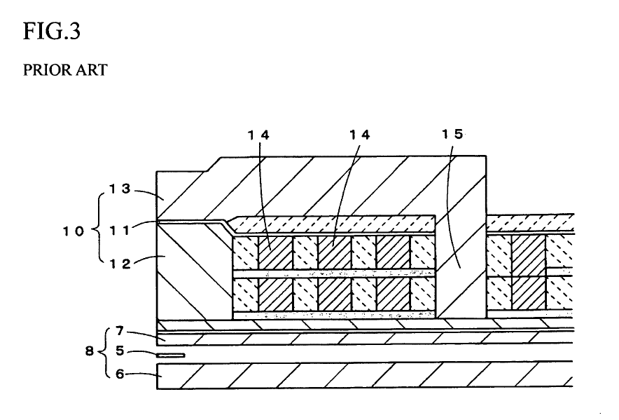

FIGS. 4A-4D explanation views showing the conventional steps of manufacturing the magnetic head

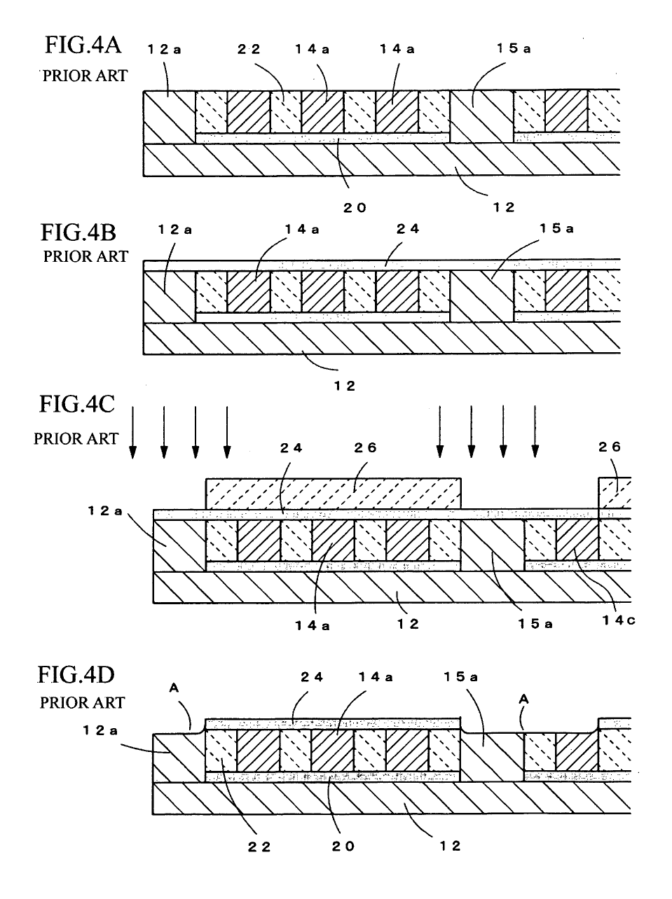

### DETAILED DESCRIPTION OF THE EMBODIMENTS

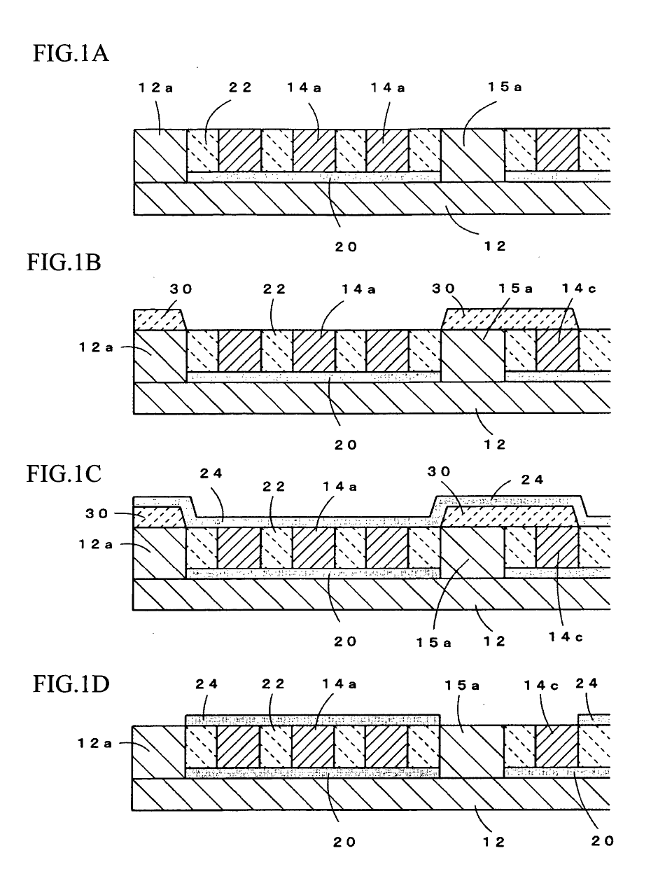

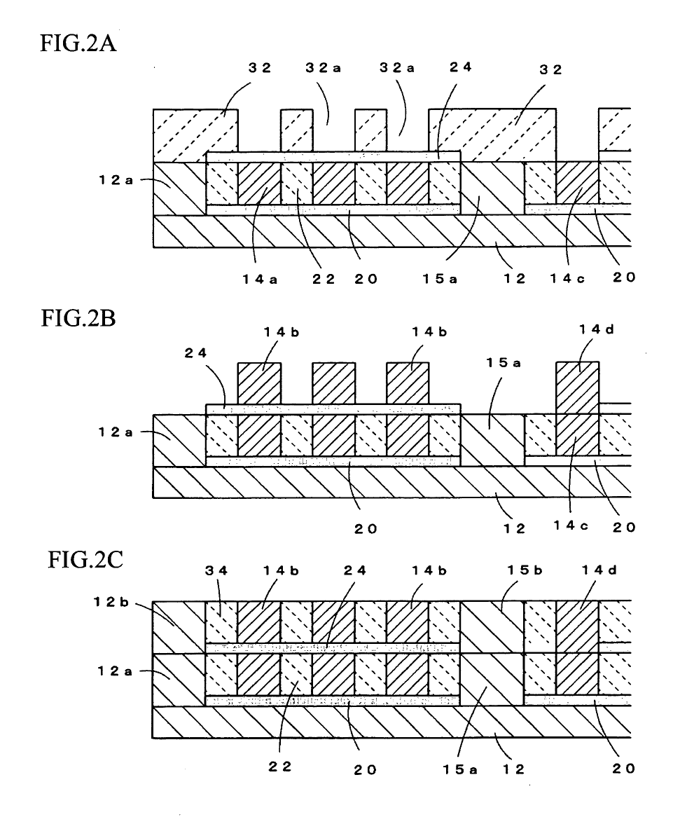

Preferred embodiments of the present invention will now be described in detail with reference to the accompanying drawings.
A unique feature of the method of the present invention is the steps of forming a write-head of a magnetic head. The steps will be explained with reference to FIGS. 1A-2C.

In FIG. 1A, a lower magnetic pole 12 and a coil 14a of a first layer are formed. The lower magnetic pole 12 is made of a magnetic material, e.g., NiFe. Firstly, the lower magnetic pole 12 having a prescribed pattern is formed on a wafer (a substrate), then an inorganic insulating film, which is made of an oxide or a nitride, e.g., alumina, SiO₂, is formed on a surface of the lower magnetic pole 12, as an insulating layer 20, by sputtering. And, the coil 14a having a prescribed pattern is formed on the insulating layer 20.

To form the coil 14a, photosensitive resist, whose thickness is thicker than that of the coil 14a, is coated on a surface of the insulating layer 20, the resist is patterned by photolithographic method so as to form a part of the coil 14a, which will be an electrically conductive part, into a groove, and the groove part is filled with copper by plating. After forming the coil 14a, the resist pattern is removed, and a spiral space in the coil 14a is filled with resist 22.

A tip magnetic pole section 12a and a connecting section 15a are formed by plating a surface of the lower magnetic pole 12 with a magnetic material.

After forming the coil 14a, the tip magnetic pole section 12a and the connecting section 15a, an entire surface of the wafer is coated with alumina by sputtering, the surface of the wafer is polished by CMP (Chemical Mechanical Polishing) method, so that surfaces of the tip magnetic pole section 12a, the coil 14a, the connecting section 15a and the resist 22 are included in the same plane. In FIG. 1A, the surfaces of the tip magnetic pole section 12a, the coil 14a, the connecting section 15a and the resist 22 are flat faces and have the same height. The step shown in FIG. 1A is the same as the conventional step.

In the present embodiment, the step shown in FIG. 1B is unique. Namely, the surfaces of the tip magnetic pole section 12a, the connecting section 15a and a connecting section 14c are coated with resist 30. The surface of the substrate other than specific parts, in which an insulating layer 24 for insulating the coil 14a of the first layer from a coil 14b of a second layer will be formed, is coated with resist 30. In other words, the tip magnetic pole section 12a and the connecting sections 15a and 14c, on which no insulating layer should be stuck, are firstly coated with the resist 30.

To coat the specific parts with the resist 30, firstly the entire surface of the wafer is coated with resist, then the wafer is optically exposed and developed so as to leave the resist 30 in the specific parts. Since many elements are arranged in the wafer, patterns of the tip magnetic pole sections 12a and the connecting sections 15a and 14c are correctly positioned and exposed so that the resist patterns 30 can be correctly formed.

The resist 30 is optically exposed and developed in a state shown in FIG. 1A, in which the surface of the wafer is highly flattened, so as to form prescribed resist patterns. Therefore, variations of thickness of the resist coating the wafer can be minimized, so that the resist can be highly precisely patterned.

Next, the entire surface of the wafer, in which the resist patterns 30 have been formed, is coated with the insulating layer 24, which is an inorganic insulating film made of, for example, alumina or SiO₂, by sputtering. In FIG. 1C, the surface of the wafer is coated with the insulating layer 24.

Then, the insulating layer 24 in the specific parts, in which the resist patterns 30 exist under the insulating layer 24, is removed, together with the resist 30, by liftoff. Namely, the resist 30 coating the surface of the wafer is removed. At that time, the insulating layer 24 adhering to the resist 30 is removed together with the resist 30.

In FIG. 1D, the resist 30 is removed by liftoff, the surfaces of the tip magnetic pole sections 12a and the connecting sections 15a and 14c, from which the resist 30 have been removed, are exposed.

The process of removing the insulating layer 24 from the specific parts by liftoff is capable of securely removing the insulating layer 24 from the specific parts, e.g., the tip magnetic pole sections 12a, the connecting sections 15a and 14c, in which no insulating layer must be left. By removing the insulating layer 24, the surfaces, which have been polished together with the coil 14a, can be exposed.

By exposing the polished surfaces of the tip magnetic pole section 12a and the connecting sections 15a and 14c as they are, their exposed surfaces can be included in the same plane. Therefore, a magnetic layer can be precisely formed on the surfaces of the tip magnetic pole section 12a and the connecting sections 15a and 14c, so that the tip magnetic pole section and the connecting sections can be finally precisely formed with prescribed thickness.

After the liftoff step, a part of the insulating layer 24, which corresponds to the coil 14a of the first layer, is left. Further, step-shaped parts of the insulating layer 24 are formed between the specific parts, which correspond to the tip magnetic pole section 12a and the connecting sections 15a and 14c, and the part corresponding to the coil 14a. Forming the step-shaped parts are previously estimated in a designing stage, so they are not formed by variations of the process. When resist is applied to the wafer so as to form a resist pattern for the coil 14b of the second layer, the resist can be patterned with high accuracy so that the coil 14b, etc. of the second layer can be precisely formed.

In FIG. 2A, the surface of the wafer, which has been processed as shown in FIG. 1D, is coated with resist 32, and the resist 32 is optically exposed and developed. A part of the resist 32, which will be the coil 14b of the second layer, are formed into a groove 32a. An upper face of the insulating layer 24 is exposed in the groove 32a.

In FIG. 2B, the groove 32a of the resist 32 is filled with copper by plating, so that the coil 14b and a coil 14d of the second layer are formed. In FIG. 2B, the resist 32 is removed after the coils 14b and 14c are copper-plated. The coil 14b of the second layer is electrically insulated from the coil 14a of the first layer by the insulating layer 24.

In FIG. 2C, spiral spaces in the coils 14b and 14d of the second layer are filled with resist 34. Further, magnetic materials are plated on the surfaces of a tip magnetic pole section 12b and a connecting section 15b so as to upwardly extend the tip magnetic pole section 12b and the connecting section 15b of the second layer.

Since the surfaces of the tip magnetic pole section 12a and the connecting section 15a of the first layer are not coated with the insulating layer 24, the tip magnetic pole section 12b and the connecting section 15b of the second layer can be electrically connected to the tip magnetic pole section 12a and the connecting section 15a of the first layer.

In the above described embodiment, when the coil 14a, the tip magnetic pole section 12a and the connecting section 15a of the first layer are formed on the wafer, the surface of the wafer is polished and flattened. The insulating layer 24 is formed on the highly flattened surface. Further, the coil 14b, etc. of the second layer can be formed on the highly flattened insulating layer 24. Therefore, even if the magnetic head is minute, the coils, the tip magnetic pole sections, etc. can be precisely formed with securing electric conductivity.

Note that, in the above described embodiment, the coils are formed as two layers. The present invention is not limited to the embodiment. For example, the coils may be formed as three layers or more. For example, after forming the coil 14b of the second layer, the surface of the wafer is flattened. Then, a part corresponding to the coil of a third layer is coated with an insulating layer by the liftoff process, and the insulating layer is removed from the specific parts. Namely, the components of the third layer can be formed as well as the components of the second layer.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of manufacturing a magnetic head, which includes a lower magnetic head, an upper magnetic head and a write-head, which is sandwiched between said magnetic heads and constituted by a plurality of layered coils,
comprising the steps of:
forming a tip magnetic pole section, which is located at a front end of said lower magnetic pole, and the coil of the first layer on a surface of a substrate;
polishing the entire surface of the substrate so as to make the entire surface of the substrate, which includes a surface of the tip magnetic pole section and a surface of the coil of the first layer, even flat face;
coating the surface of the substrate other than specific parts, which electrically insulate the coil of the first layer from the coil of a second layer, with resist;
coating the entire surface of the substrate, on which the resist has been applied, with an insulating layer;
removing the insulating layer from the specific parts together with the resist by liftoff; and
forming the coil of the second layer on the insulating layer formed on the substrate.

2. The method according to claim 1,
further comprising the step of forming a tip magnetic pole section of an upper layer, which is electrically connected to the tip magnetic pole section.

3. The method according to claim 1,
wherein a connecting section, which connects said lower magnetic pole with said upper magnetic pole, is formed when the tip magnetic pole section is formed in the surface of the substrate, and
the entire surface of the substrate, which includes the surface of the tip magnetic pole section, the surface of the coil of the first layer and a surface of the connecting section, is polished and formed into the even flat face.

4. The method according to claim 1,
further comprising the steps of:
polishing the entire surface of the substrate, which includes the surface of the coil of the second layer, so as to make the entire surface even flat face;
coating the surface of the substrate other than specific parts, which electrically insulate the coil of the second layer from a coil of a third layer, with resist;
coating the entire surface of the substrate, on which the resist has been applied, with another insulating layer;
removing the insulating layer from the specific parts together with the resist by liftoff; and
forming the coil of the third layer on the insulating layer formed on the substrate.
